(19) United States
(12) Patent Application Publication
(10) Pub. No.: US 2006/0050252 A1
(43) Pub. Date: Mar. 9, 2006

(54) OPTICAL PROJECTION APPARATUS AND ASSEMBLING METHOD THEREOF

(76) Inventors: Tsung-Jung Hsu, Taoyuan County (TW); Ching-Chao Chen, Taoyuan Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,826

(22) Filed: Aug. 18, 2005

(30) Foreign Application Priority Data
Sep. 7, 2004 (TW) 93126971

(51) Int. Cl. G03B 21/14

(52) U.S. Cl. 353/119

(57) ABSTRACT

An optical projection apparatus and assembling method thereof are disclosed. The method includes providing a precise calibration fixture, a projection lens, a display module and an optical engine. The projection lens and the optical engine and then the display module and the precise calibration fixture are assembled together. An image calibration operation is performed so that the position of the display module relative to the projection lens is adjusted through the precise calibration fixture. Thereafter, the display module and the optical engine are assembled using glue. The aforementioned apparatus and assembling method can improve the focusing characteristic of images and resolve image-tilting and image-shifting problems.

### CROSS-REFERENCE TO RELATED APPLICATION

This application claims the priority benefit of Taiwan application serial no. 93126971, filed on Sep. 7, 2004. All disclosure of the Taiwan application is incorporated herein by reference.

### BACKGROUND OF THE INVENTION

1. Field of the Invention

The present invention relates to an optical projection apparatus and assembling method thereof. More particularly, the present invention relates to an optical projection apparatus and assembling method thereof that can improve focusing characteristic, resolve image-tilting and image-shifting problems, shorten production time and reduce cost.

2. Description of the Related Art

In recent years, liquid crystal display devices are increasingly used in direct viewing display devices, such as display screens, notebook computers, digital television. Moreover, liquid crystal display devices are also used in indirect viewing display devices deployed by liquid crystal projectors and rear projection television, such as liquid crystal on silicon (LCOS) panels, high-temperature polysilicon liquid crystal display (HTPS-LCD) panels and digital micro-mirror devices (DMD). Due to the size limitation of a direct viewing display device, a high-resolution indirect viewing display panel together with an optical engine is often the preferred means of fabricating a rear projection projector or a rear projection television with a large screen.

Most rear projection display products utilize an optical engine to produce and project an image on a screen. To focus and position the image produced by the optical engine on a projection screen with great accuracy, an adjusting device must be used to perform an image calibration operation.

FIG. 1 is a schematic view showing the structure of a conventional optical projection apparatus. A conventional optical projection apparatus mainly comprises a projection lens 110, a display module 120, an optical engine 130 and a lens calibration assembly 150. The method of assembling a conventional optical projection apparatus includes fastening the display module 120 to the optical engine 130 using screws. Thereafter, the projection lens 110 is fastened to the lens calibration assembly 150 which is temporarily fastened to the optical engine 130. Through the lens calibration assembly 150, the relative position between the projection lens 110 and the display module 120 can be adjusted to move the image up or down and left or right and ultimately bring the image to a desired location.

Accordingly, the quality of projected image in a conventional optical projection apparatus depends on the parallel alignment between the projection lens 110 and the display module 120 as well as the distance (rear focus) between the projection lens 110 and the display module 120. Because a number of components are disposed between the display module 120 and the projection lens 110, cumulative tolerance is often produced leading to some instability in the quality of the focused image. Furthermore, the lens calibration assembly 150 can only perform simple image focusing operation and directional adjustments.

However, if the projected image is tilted, cushioning plate must be added to cushion up the optical engine so that the image-tilting problem is resolved. Such adjustment is not only time-consuming, but also difficult to control. In addition, the position of the lens calibration assembly 150 relative to the optical engine 130 needs to be fixed after the image has been properly adjusted to the desired location. If the relative position is fixed using a screw, too much torque applied to the screw may lead to a shift of the image so that the lens calibration assembly 150 has to be loosened again for another readjustment. Furthermore, the introduction of a structurally complex lens calibration assembly 150 inside the projection apparatus also increases manufacturing cost.

### SUMMARY OF THE INVENTION

Accordingly, the primary object of the present invention is to provide an optical projection apparatus and assembling method thereof for improving focusing characteristic, resolving image-tilting and image-shifting problems, shortening production time and reducing production cost.

Another object of the present invention is to provide an optical projection apparatus and assembling method thereof that utilizes a precise calibration fixture for improving focusing characteristic, resolving image-tilting and image-shifting problems, shortening production time and reducing production cost.

A further object of the present invention is directed to provide an optical projection apparatus that facilitates the maintenance and calibration of a display module inside the apparatus.

As embodied and broadly described herein, the invention provides an optical projection apparatus and assembling method thereof. The method includes providing a projection lens, a display module and an optical engine. The projection lens is assembled to the optical engine. Thereafter, the relative position between the display module and the projection lens is adjusted in an image calibration operation. After that, the display module is assembled to the optical engine.

In the aforementioned apparatus and assembling method, the projection lens is fastened to the optical engine by tightening a set of screws and the display module is fastened to the optical engine by glue, for example.

In the aforementioned apparatus and assembling method, the calibration of the image on the display screen includes adjusting the focus of the image, adjusting the horizontal and vertical position of the image and adjusting the angle of tilt of the image.

The present invention also provides another optical projection apparatus and assembling method thereof comprising the following steps. First, a precise calibration fixture, a projection lens, a display module, a display screen and an optical engine are provided. Thereafter, the projection lens is assembled to the optical engine and then the display module is fastened to the precise calibration fixture. Using the precise calibration fixture, the relative position between the display module and the projection lens is adjusted to calibrate the image projected from the projection lens. When the image projected on the display screen is calibrated to a precise location, the display module is fastened to the optical engine by glue.

In the aforementioned apparatus and assembling method, the projection lens is fastened to the optical engine by tightening a set of screws, for example.

In the aforementioned apparatus and assembling method, the calibration of the image on the display screen includes using the precise calibration fixture to adjust the focus of the image on the display screen, using the precise calibration fixture to adjust the horizontal and vertical position of the image on the display screen so that the accuracy is within 0.5 of a pixel and using the precise calibration fixture to adjust the angle of tilt of the image on the display screen.

In the aforementioned apparatus and assembling method, after fastening the display module to the optical engine by glue, further includes releasing the display module so that the display module on the optical engine detaches from the precise calibration fixture.

In the aforementioned apparatus and assembling method, the precise calibration fixture comprises an adjustable fixture having six axial degrees of freedom.

The present invention also provides an optical projection apparatus comprising a projection lens, a display module and an optical engine. The display module has a plurality of gluing holes and a plurality of device positioning holes. The optical engine has a plurality of alignment pins capable of passing through the gluing holes so that the display module can be fastened to the optical engine by the glue.

In the aforementioned optical projection apparatus, the display module further comprises a display device, a circuit board, a display device fastener module and a frame. The display device fastener module is capable of stationing the display device on the circuit board. The frame connects the optical engine with the display device fastener module. The gluing holes and the device positioning holes are disposed on the frame. The frame connects with the optical engine through the gluing holes and a gluing compound. The frame is connected to the display device fastener module through the device positioning holes.

In the aforementioned optical projection apparatus, the display device comprises a digital micro-mirror device.

In the aforementioned optical projection apparatus, the circuit board has a first surface and a second surface and the display device is fastened to the first surface of the circuit board, for example.

In the aforementioned optical projection apparatus, the display device fastener module further comprises a first holder and a second holder. The first holder is disposed on the first surface of the circuit board and the second holder is disposed on the second surface of the circuit board. The display device is disposed on the first surface of the circuit board through the first holder and the second holder, for example.

In the aforementioned optical projection apparatus, the circuit board has a first opening and the second holder has a second opening such that the second opening corresponds to the first opening, for example.

In the aforementioned optical projection apparatus, a heat sink may be disposed inside the first opening of the circuit board and the second opening of the second holder.

In the aforementioned optical projection apparatus, the display module may further comprises a plurality of locking elements for locking the second holder, the circuit board and the first holder to the device positioning holes on the frame.

In brief, the optical projection apparatus and assembling method of the present invention includes fastening the projection lens to the optical engine before calibrating the relative position between the display module and the projection lens. Hence, the display module in the forward/backward, left/right and up/down direction can be freely adjusted to control the location of the image projected from the projection lens. Furthermore, because the rotation angle of the display module can be adjusted, image-tilting problem is also resolved. It should be noted that the adjusting device in present invention does not have to be incorporated into the product. Thus, overall production cost can be reduced.

It should be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view showing the structure of a conventional optical projection apparatus.

FIG. 2 is a flow chart showing the steps for assembling an optical projection apparatus according to one preferred embodiment of the present invention.

FIGS. 3A through 3D are schematic view s showing the optical projection apparatus and the steps for assembling an optical projection apparatus according to one preferred embodiment of the present invention.

FIG. 4 is an exploded view showing various structural components of a display module according to one preferred embodiment of the present invention.

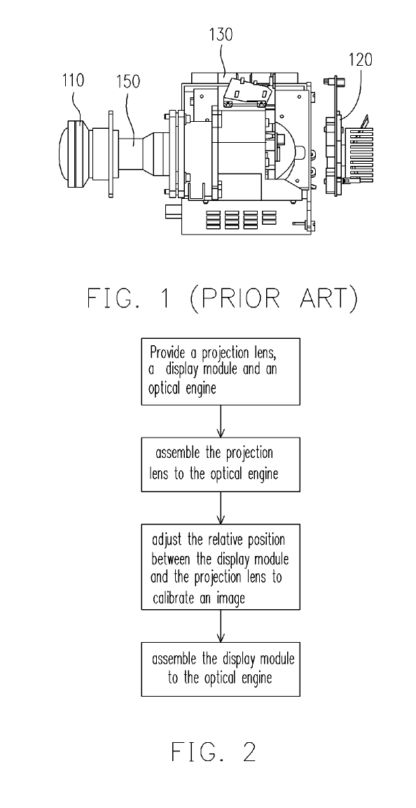

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

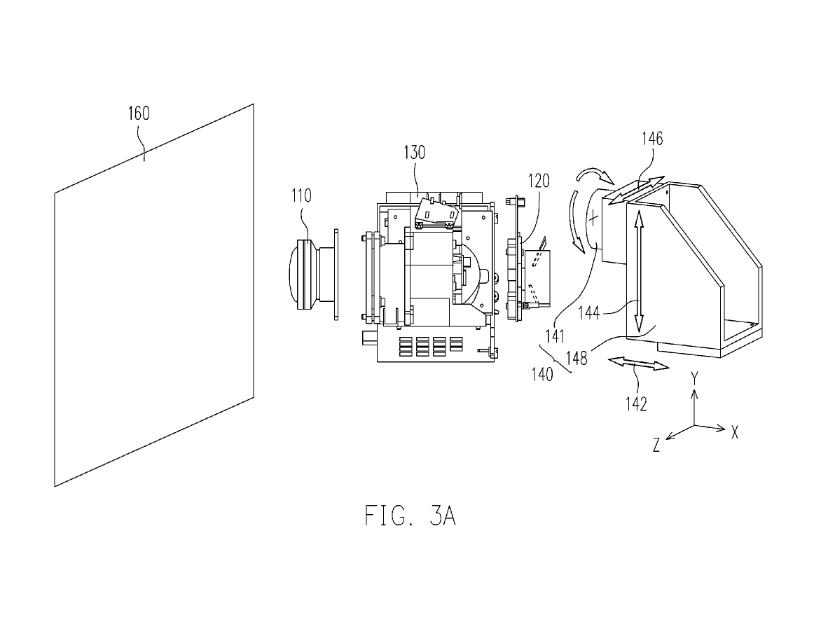

As shown in FIGS. 2, 3A and 4, a projection lens 110, a display module 120 and an optical engine 130 are provided. The display module 120 further comprises a frame 121, a display device fastener module comprising a first holder 122 and a second holder 125, a display device 123, and a circuit board 124. The display device 123 is a digital micro-mirror device, for example. In addition, the frame 121 comprises a plurality of device positioning holes 121 a and a plurality of gluing holes 121b, for example.

In one preferred embodiment of the present invention, a set of locking elements 128b is used to tighten the first holder 122, the circuit board 124 and the second holder 125 to the device positioning holes 121a on the frame 121. Hence, the display device 123 is stationed between the first holder 122 and the circuit board 124. Furthermore, by passing a plurality of alignment pins 131 on the optical engine 130 through the gluing holes 121b and a plurality of fastening rings 128a, the display module 120 is temporarily stationed on the optical engine 130. The fastening rings 128a are disposed within fastener ring positioning holes 124b of the circuit board 124.

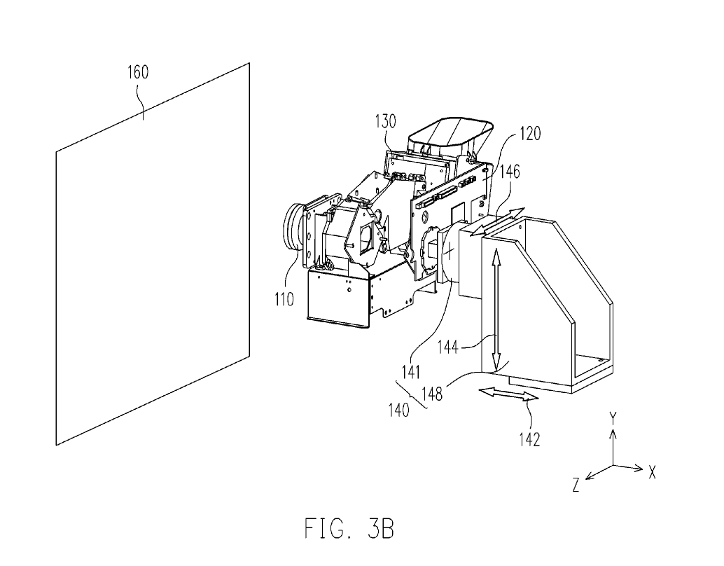

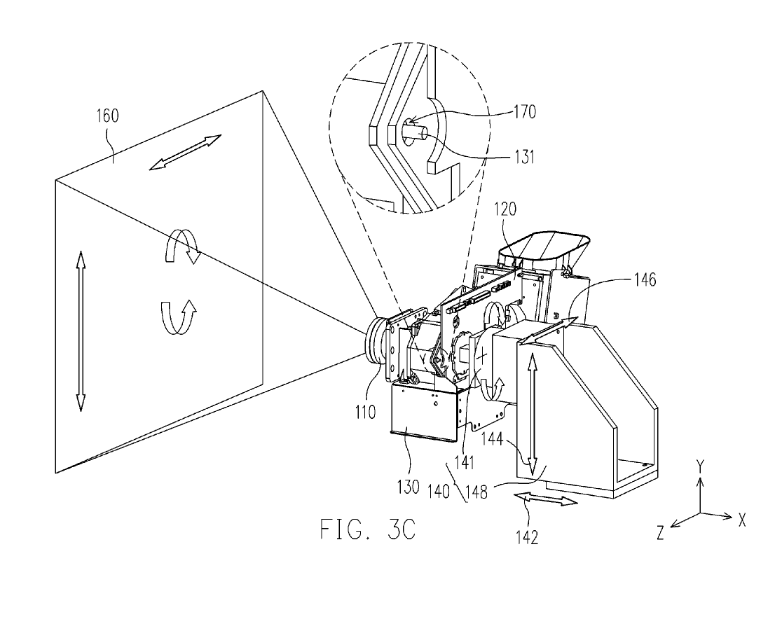

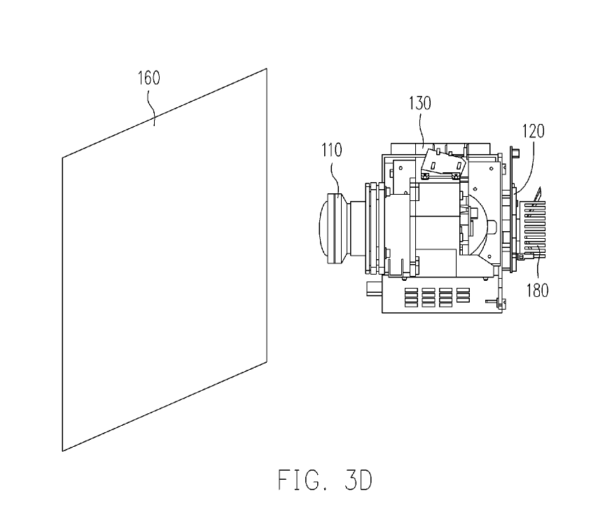

In the present embodiment, a precise calibration fixture 140 may also be provided for image adjustment besides providing the projection lens 110, the display module 120, a display screen 160 and the optical engine 130. The graduations on the precise calibration fixture 140 can have an accuracy smaller than 0.01 mm, for example. However, the calibration of the relative position between the display module 120 and the projection lens 110 can be carried out by using any precise calibration fixture other than the precise calibration fixture 140 shown in FIG. 3A.

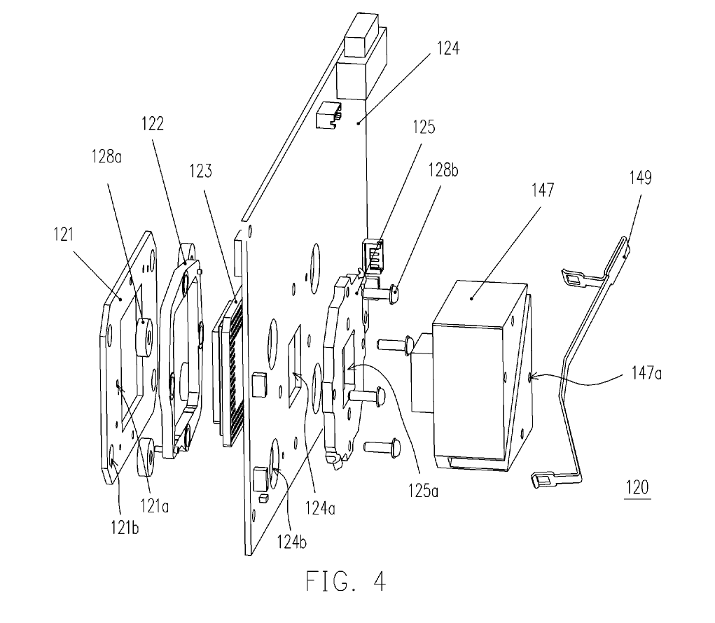

As shown in FIGS. 3A and 4, the precise calibration fixture 140 in the present embodiment is suitable for assembling a display module 120 to an optical engine 130 with a projection lens 110. The precise calibration fixture 140 comprises a main body 148, a display module fastener 141, a clamp 147 and a spring plate 149. The main body 148 is designed to calibrate the display module 120. The display module fastener 141 and the main body 148 are connected together and the display module fastener 141 is designed to station the display module 120. Furthermore, the main body 148 and the display module fastener 141 are designed to shift and rotate the display module 120 in six axial directions.

In one preferred embodiment of the present invention, the main body 148 of the precise calibration fixture 140 controls the movement of the display module 120. In other words, the precise calibration fixture 140 is free to move forward/backward 142 in the X direction, up/down 144 in the Y direction and left/right 146 in the Z direction. In addition, the display module fastener 141 controls the rotation of the display module 120. That means, the precise calibration fixture 140 may rotate along the X, Y and Z-axis to adjust the display module 120. In most calibrating operations, the precise calibration fixture 140 rotates along the X-axis.

As shown in FIGS. 3B and 4, the projection lens 110 is assembled to the optical engine 130. In the present embodiment, the method of assembling the projection lens 110 and the optical engine 130 together includes, for example, tightening with a set of screws or some other fastening means. Thereafter, the display module 120 is temporarily fastened to the display module fastener 141 of the precise calibration fixture 140. In the present embodiment, the fastening is achieved by inserting the alignment pins (not shown) on the display module fastener 141 into the holes 147a in the clamp 147 and then fixing the clamp 147 on the second holder 125 via the spring plate 149, so that the display module 120 is temporarily fastened to the display module fastener 141. However, the method of joining the display module 120 and the display module fastener 141 together is not limited to the aforementioned alignment pin/hole combination. Other fastening methods including interlocking each other together by using of a set of screws, for example, may also be applied.

As shown in FIG. 3C, the display module 120 on the precise calibration fixture 140 is preliminarily fastened to the optical engine 130. Because the display module 120 is only loosely fastened to the optical engine 130, gaps 170 are reserved to perform minor adjustments. Thereafter, through the movement of the main body 148 and/or the rotation of the display module fastener 141, the relative position between the display module 120 and the projection lens 110 is adjusted. Ultimately, the image on the display screen 160 projected from the projection lens 110 falls within an accuracy of 0.5 pixel. In the present embodiment, the calibration of image is carried out by using the forward/backward movement 142 of the main body 148 to adjust the focus, the left/right movement 146 of the main body 148 to adjust the horizontal position of the display module 120, the up/down movement 144 of the main body 148 to adjust the vertical position of the display module 120 and the left/right tilting movement of the display module fastener 141 to adjust the angle of tilt of the display module 120 along the X-axis.

As shown in FIGS. 3D and 4, after calibrating the image on the display screen 160 to a suitable location using the precise calibration fixture 140, the display module 120 is glued to the optical engine 130. The display module 120 and the optical engine 130 are joined by glue instead of screws to prevent any shift in the image when the screws are tightened. The display module 120 is connected to the optical engine 130 by passing alignment pins 131 on the optical engine 130 through the gluing holes 121b in the frame 121 and then applying some glue to the holes 121b. After that, the display module 120 on the precise calibration fixture 140 is released so that the display module 120 assembled to the optical engine 130 detaches from the precise calibration fixture 140. Furthermore, the clamp 147 is detached from the display module 120. Thereafter, a heat sink 180 is lowered through the second opening 125a of the second holder 125 and the first opening 124a of the circuit board 124 to contact the display device 123 so that heat generated by the display device 123 can be easily channeled away.

It should be noted that the frame 121 of the display module 120 is fixed on the optical engine 130 via a gluing process. Furthermore, the first holder 122, the circuit board 124 and the second holder 125 are locked on the device positioning holes 121a on the frame 121 by using the locking elements 128b. Therefore, if the display module 120 needs to be maintained or serviced, only by dismantling the locking elements 128b then the first holder 122, the display device 123, the circuit board 124 and the second holder 125 can be easily taken apart. Because the frame 121 is still fastened to the optical engine 130, there is no need to perform a readjustment after the maintenance or service of the first holder 122, the display device 123, the circuit board 124 and the second holder 125 are finished and then the same are reassembled.

If it is necessary to readjust the display module 120 again, the precise calibration fixture 140 can be reused after detaching the frame 121 from the optical engine 130. Hence, the optical projection apparatus and assembling method of the present embodiment can be maintained or readjusted in a few simple steps.

In addition, the precise calibration fixture used for setting the relative position between the display module 120 and the projection lens 110 is given as an example only. Hence, other type of fixtures modified within the scope of the present invention may also be used.

In summary, one major aspect of the optical projection apparatus and assembling method of the present invention is the fastening of the projection lens to the optical engine firstly before setting the relative position between the display module and the projection lens. This method differs from the conventional technique of fastening the display module to the optical engine by screws, locking the lens calibration assembly temporarily to the optical engine and then using the lens calibration assembly to set the relative position between the projection lens and the display module. The precise calibration fixture of the present invention permits the display module to move in various directions so that the projected image is positioned to whatever location on the display screen. Furthermore, without the lens calibration assembly between the display module and the projection lens, cumulative tolerance is reduced and the quality of the focused image is improved. Moreover, the precise calibration fixture also permits an angular rotation of the display module to resolve image-tilting problems. In addition, using glue to join the display module and the optical engine together instead of a set of screws prevents a minor shifting of the image position when the screws are tightened and the present invention also save some assembling time. Last but not least, the present invention is able to reduce overall production cost because there is no need to set up calibration device within the products.

It will be apparent to those skilled in the art that various modifications and variations can be made to the structure of the present invention without departing from the scope or spirit of the invention. In view of the foregoing, it is intended that the present invention covers modifications and variations of this invention which fall within the scope of the following claims and their equivalents.

What is claimed is:

1. A method of assembling an optical projection apparatus, comprising the steps of:
providing a projection lens, a display module, a display screen and an optical engine;
assembling the projection lens to the optical engine;
adjusting the relative position between the display module and the projection lens to calibrate an image projected on the display screen from the projection lens; and
assembling the display module to the optical engine after the image projected on the display screen is accurately calibrated.

2. The assembling method of claim 1, wherein the projection lens is assembled to the optical engine by screws.

3. The assembling method of claim 1, wherein the step of calibrating the image on the display screen comprises:
adjusting a focus of the image;
adjusting a horizontal and vertical position of the image; and
adjusting an angle of tilt of the image.

4. The assembling method of claim 1, wherein the display module is assembled to the optical engine by glue.

5. A method of assembling an optical projection apparatus, comprising the steps of:
providing a precise calibration fixture, a projection lens, a display module, a display screen and an optical engine;
assembling the projection lens to the optical engine;
fastening the display module on the precise calibration fixture;
adjusting the relative position between the display module and the projection lens using the precise calibration fixture to calibrate an image projected on the display screen from the projection lens; and
assembling the display module to the optical engine by glue after the image projected on the display screen is accurately calibrated.

6. The assembling method of claim 5, wherein the projection lens is assembled to the optical engine by tightening a set of screws.

7. The assembling method of claim 5, wherein the step of calibrating the image on the display screen comprises:
adjusting a focus of the image on the display screen using the precise calibration fixture;
adjusting a horizontal and vertical position of the image on the display screen using the precise calibration fixture so that the degree of accuracy is within 0.5 of a pixel; and
adjusting an angle of tilt of the image on the display screen using the precise calibration fixture.

8. The assembling method of claim 5, wherein after gluing the display module to the optical engine, further comprises releasing the display module so that the display module on the optical engine is detached from the precise calibration fixture.

9. The assembling method of claim 5, wherein the precise calibration fixture comprises an adjusting fixture that provides precise movement in six axial directions.

10. An optical projection apparatus, comprising:
a projection lens;
a display module having a plurality of gluing holes and a plurality of device positioning holes; and
an optical engine having a plurality of alignment pins that can pass through the gluing holes on the display module and fasten the display module to the optical engine by glue.

11. The optical projection apparatus of claim 10, wherein the display module further comprises:
a display device;
a circuit board;
a display device fastener module for fastening the display device to the circuit board; and
a frame connecting the optical engine and the display device fastener module such that the gluing holes and the device positioning holes are located above the frame, wherein the frame is connected to the optical engine by applying glue into the gluing holes and the frame is connected to the display device fastener module through the device positioning holes.

12. The optical projection apparatus of claim 11, wherein the display device comprises a digital micro-mirror device.

13. The optical projection apparatus of claim 11, wherein the circuit board has a first surface and a second surface such that the display device is fastened to the first surface of the circuit board.

14. The optical projection apparatus of claim 13, wherein the display device fastener module further comprises:
a first holder disposed on the first surface of the circuit board; and
a second holder disposed on the second surface of the circuit board, wherein the display device is disposed on the first surface of the circuit board through the first holder and the second holder.

15. The optical projection apparatus of claim 14, wherein the display module further comprises a plurality of locking elements for locking the second holder, the circuit board and the first holder to the device positioning holes on the frame.
